(19) United States
(12) Patent Application Publication
(10) Pub. No.: US 2013/0320664 A1
(43) Pub. Date: Dec. 5, 2013

(54) CONNECTOR

(71) Applicant: Rolf Wium, Drammen (NO)

(72) Inventor: Rolf Wium, Drammen (NO)

(73) Assignee: Roxar Flow Measurement AS, Stavanger (NO)

(21) Appl. No.: 13/881,778

(22) PCT Filed: Oct. 13, 2011
(86) PCT No.: PCT/NO11/00292

§ 371 Date: Jun. 25, 2013

(30) Foreign Application Priority Data
Oct. 27, 2010 (NO) 20101506

(51) Int. Cl. F16L 25/02; F16L 58/00

(52) U.S. Cl. CPC F16L 25/025; F16L 58/00
USPC 285/54

(57) ABSTRACT

The invention provides a connector, comprising a male member and a female member, one of said members is stationary whilst the other member is retrievable. The connector is distinctive in that the interface between the male and female members comprises a facing surface of a ceramic sleeve, ceramic insert or ceramic member, such that the male and female members are galvanically isolated.

### FIELD OF THE INVENTION

The present invention relates to connectors. More specifically the invention relates to connectors located subsea, particularly as integrated into, connected to or located nearby installations that are cathodically protected by sacrificial anodes, applied current or a combination thereof.

### BACKGROUND OF THE INVENTION AND PRIOR ART

Units located subsea may fail, but repair or replacement is more difficult and expensive than for units at dry locations.

Connectors are one type of units or equipment that may fail. Hydraulic, electro-hydraulic or electro-optical-hydraulic connectors for operation subsea are often designed with one stationary part and one retrievable part. The stationary part is often designed to be more reliable than the retrievable part, which means that damage or failure is intended to take place on the retrievable, easier replaceable part. One typical design is the so called stab connector, stabber or hot stab, often used in subsea valve trees (X-mas trees) and other subsea equipment used in the oil and gas industry.

However, deposits of many kinds are often a problem for such connectors, as the sealing surfaces, which surfaces can not be painted, may become useless due to deposit formation. Soft and hard marine growth and scales are known types of deposits, as well as whirled up seabed particles. The deposits increase wear and galling and formation of damages such as scratches, in addition to destroying the geometrical matching of the connector parts, thereby reducing the service life of the connector.

A demand exists for connectors for use subsea, which connectors are without or with a significant reduction in formation of deposits. The objective of the invention is to meet said demand.

### SUMMARY OF THE INVENTION

The invention provides a connector, comprising a male member and a female member, one of said members is stationary whilst the other member is retrievable. The connector is distinctive in that the interface between the male and female members comprises a facing surface of a ceramic sleeve, ceramic insert or ceramic member, such that the male and female members are galvanically isolated.

The term that the interface between the male and female members comprises a facing surface of a ceramic sleeve, ceramic insert or ceramic member, such that the male and female members are galvanically isolated, means that a part of or all of at least one of the members, in at least the part containing the sealing surface, is made of a ceramic material that is non-conductive with respect to electric current. Accordingly, the male and female members are electrically isolated from each other.

The connector is for use subsea, for operation as integrated into, connected to or located nearby installations that are cathodically protected by sacrificial anodes, applied current or a combination thereof.

Surprisingly, the connector of the invention is far less susceptible or vulnerable for deposit formation, hence, the service life is prolonged over prior art connectors. Without wishing to be bound by theory, it is assumed that the galvanic isolation of the members, at the sealing faces, particularly in an environment affected by cathodic protection, such as having the connector electrically connected to means for cathodic protection, results in a significantly reduced rate of depositing. More specifically, it seems like the rate of deposit, particularly for typical hard deposits such as calcium or calcareous deposits, are related in some way to the cathodically protecting surface current of the sealing surfaces. Such hard deposits are the main concern with respect to long service life of the connector, causing scratches and geometrical mismatch.

The connector can therefore be connected to X-mas trees, pipelines and other equipment that are protected by sacrificial anodes or other means for cathodic protection. Around structures that are cathodically protected an electric field may exist, influencing negative on the rate of deposit formation, and also such locations are affected by cathodic protection and are particularly relevant for the connectors of the invention.

Preferably the connector comprises a retrievable male stab member and a stationary female member, the female member includes an internal ceramic sleeve, the inner surface of the sleeve constitutes the sealing surface toward the male member. Preferably, the ceramic sleeve is compression -, heat-, or press fit into the female member at a moderate tolerance, typically 0,01-0,15, most preferable 0,03-0,05 mm difference in diameter. The female member will thereby have a convenient pretension or bias on the ceramic sleeve. Surprisingly, testing has revealed that such fit and tolerance provides a good enough sealing, without leakage, between the sleeve and the surrounding metal part of the female member. However, additional or alternative means to avoid leakage from or to bores or ports between metal and a ceramic sleeve can be included, such as pipe socket inserts in the bore or sealing elements or sealing layers in between metal and ceramic material of a member.

The male member preferably is a stab member with an ROV handle for remote operation by an ROV, the male member comprises bores or ports and seals are arranged on either side of each port or bore opening.

Ports of the male member fit sealingly to ports and bores of the female member when the members are in mated position, thereby making up the connection.

The ceramic material of the connector is preferably electric non-conductive zirconium oxide or based on zirconium oxide, but also other materials are feasible, for example as a insert or sleeve or as the body of the female member. Other ceramics, either non-electric conductive or with non-electric conductive material sandwiched in between, such as oxides, borides, nitrides, silicides and carbides, can be alternative materials, for example silicon carbides are known for their scratch resistance.

The male and female members are preferably made of metal, except for a ceramic sleeve in the female member. The metal is preferably a stainless steel, such as Nitronic 50, 6 Mo, 316 or other austenitic stainless steel, or duplex or super duplex steel, or other metal such as Inconel 625. If the connector is galvanically connected directly to a structure, or is subject to cathodic protection in itself, the metal material only need to be galvanically equal or more cathodic, i.e. more noble, in seawater service than the structure it is connected to.

Alternatively, one of the connector members, preferably the female part, is made of a ceramic material. Which member of the female and male member that is the stationary part can be chosen freely, however, it is advisable that the most resistant member is the stationary part since replacement of the stationary part is far more expensive than for the retrievable part.

### FIGURE

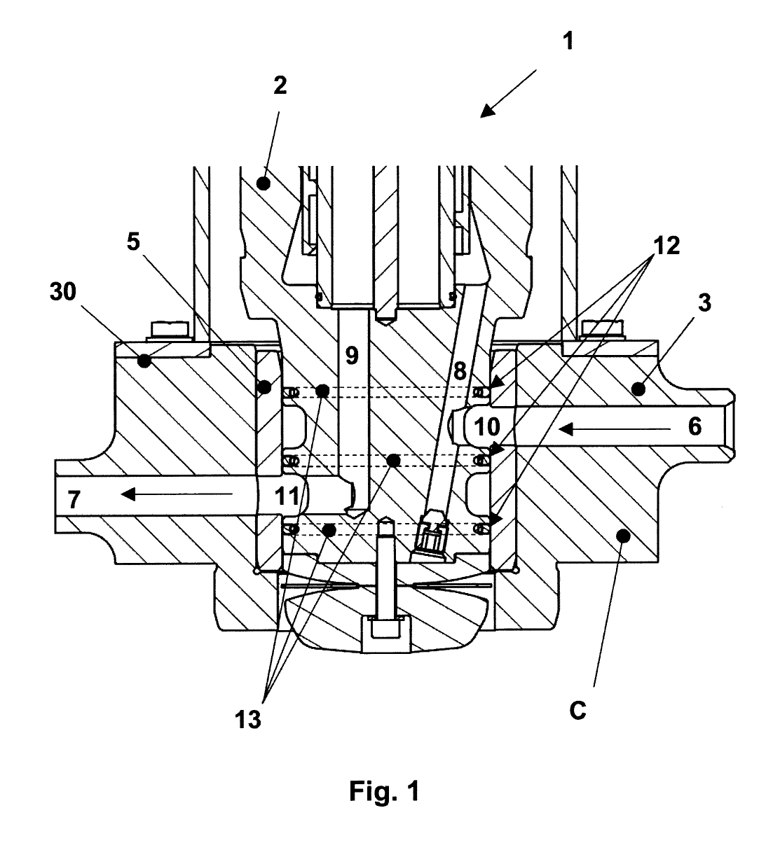

The invention is illustrated with one FIGURE, namely FIG. 1 illustrating a connector of the invention.

### DETAILED DESCRIPTION

Reference is made to FIG. 1, illustrating in cross section a part of a connector according to the invention. More specifically, a connector 1, comprising a male retrievable member 2 and a female stationary member 3, is illustrated. For clarity the male member is not hatched. In the illustrated embodiment the interface between the male and female members comprises a facing surface of a ceramic sleeve 5. The ceramic sleeve 5 provides galvanic isolation between the male and female members and improves the scratch resistance and reduces friction. The outer metal part 30 of the stationary female member 3 is subject to cathodic protection C. The outer stationary female member 3 comprises two fluid ports, namely one fluid inlet 6 and one fluid outlet 7. The fluid ports of the female member is fluidly connected to bores 8, 9 and corresponding ports 10,11 of the male member, as drafted with dotted lines. On the male member seals 12 are arranged in dedicated seal grooves 13 on either side of each male member port, thereby providing a pressure/force balanced connector.

The technical effect achieved with the connector of the invention can be summarized as follows:
The hard ceramic surface is resistant to scratches during retrieving/remating operations in contaminated environment, hence, scratches are in substance eliminated.
Low friction between the ceramics surface and the seals ensure low forces during retrieving/remating operations.
Electrical isolation gives no or significantly reduced rate of deposits formation, particularly calcium or calcareous deposits on uncoated metallic surfaces, particularly when the connector is affected by cathodic protection.
Prolonged service life.
Reduced cost over the service life.

The connector of the invention is not only subject to a significant reduction of deposits on the uncoated sealing surfaces, any deposits will be tolerated better because of better scratch resistance and because the deposits, if any, to a larger extent will be soft deposits.

1. A connector, comprising:
a male member and a female member, at least one of the male member and the female member is stationary while the other member is retrievable,
wherein an interface between the male member and the female member comprises a facing surface of at least one of a ceramic sleeve, ceramic insert, and ceramic member, such that the male member and the female member are galvanically isolated,
wherein the connector is for use subsea, for operation as integrated into, connected to or located nearby installations that are cathodically protected by sacrificial anodes, applied current or a combination thereof.

2. The connector according to claim 1, comprising a retrievable male stab member and a stationary female member, the female member includes an internal ceramic sleeve, the inner surface of the sleeve constitutes the sealing surface toward the male member.

3. The connector according to claim 2, wherein the ceramic sleeve is at least one of compression -, heat-, or press fit into the female member at a moderate tolerance.

4. The connector according to claim 1, wherein:
the male member is a stab member with an ROV handle for remote operation by an ROV; and
the male member comprises bores with ports and seals are arranged on either side of each port.

5. The connector according to claim 1, wherein the ceramic material of the connector is zirconium oxide.

6. The connector according to claim 1, wherein the male member and the female member are made of metal, except for a ceramic sleeve in the female member.

7. The connector according to claim 1, wherein at least one of the male member and the female member is made of a ceramic material.

8. The connector of claim 3, wherein the moderate tolerance comprises a difference in the range of approximately 0.01 mm to approximately 0.15 mm between a diameter of the ceramic sleeve and a diameter of the female member.

9. The connector of claim 3, wherein the moderate tolerance comprises a difference in the range of approximately 0.03 mm to approximately 0.05 mm between a diameter of the ceramic sleeve and a diameter of the female member.
